(19) United States
(12) Patent Application Publication
(10) Pub. No.: US 2003/0195759 A1
(43) Pub. Date: Oct. 16, 2003

(54) Computer assisted contracting of application services

(76) Inventors: David H.J. Glassco, Surrey (CA); Martin M. Lacey, Surrey (CA)

Correspondence Address: SCHWABE, WILLIAMSON & WYATT, P.C., PACWEST CENTER, SUITES 1600-1900, 1211 SW FIFTH AVENUE, PORTLAND, OR, 97204, US

(21) Appl. No.: 10/158,290

(22) Filed: May 29, 2002

Related U.S. Application Data
(60) Provisional application No. 60/372,159, filed on Apr. 12, 2002.

(51) Int. Cl. G06F 17/60

(52) U.S. Cl. 705/1

(57) ABSTRACT

An application service environment is equipped to facilitate formation of an application service agreement between a first and a second organization. The facilitation includes facilitating an authorized user of the first organization in creating an offer to form the application service agreement, with the offer comprising one or more offer data object instances having one or more attributes describing the offer, and the offer data object instances having association with one or more methods for an authorized user of the second organization to accept the offer or create a counter offer to the offer. The facilitation may further include facilitating an authorized user of the second organization using the first one or more methods to accept the offer or create a counteroffer.

### Related Application

This is a non-provisional application of provisional application number 60/372,159, filed Apr. 12, 2002, entitled, “Financial Application Services Including Automatic Service Contract Formation and Subscriber Offering of Data Objects”. This application claims priority to said provisional application.

### BACKGROUND OF THE INVENTION

1. Field of the Invention

The present invention relates to the field of electronic data/information processing. More specifically, the present invention relates to methods and apparatuses for providing application services including computer assisted contracting of selective aspects of the application services.

2. Background Information

Typically, user access to applications and data are controlled through user logons and user profiles administered by system administrators. Users are required to logon to individual application and/or file servers. Once logged on to an application/file server, a user's access authority to applications and/or data on the server is governed by the user's profile created and maintained by a system administrator. For example, if a system administrator has classified the user as a privileged user, as opposed to an unprivileged user, the control software of the server (e.g. the file subsystem, or the operating system itself) allows the user certain creation or deletion authority otherwise not available to other users classified as unprivileged users. On file servers, individual users may exercise further control or protection by e.g. password protecting or encrypting their own data, and controlling effective access and/or usage of these further protected data by controlling the distribution and sharing of the passwords and/or decryption keys.

With the advance of telecommunication and networking technology, and the availability of public data networks, such as the Internet, increasingly users are “interconnected” together, and applications as well as data need to be shared in a controlled manner among a very large set of user population with very different access needs. These earlier described log-on and system administrator administered user profile based prior art approaches are no longer able to provide the control with the desired flexibility and ease of administration. The problem is further compounded with function rich applications or hosted applications (commonly known as application services), such as the financial applications or application services available from FinancialCAD of Surrey, Canada, assignee of the present application, where user accesses and licensing are flexibly administered at a function offering or service level.

In co-pending U.S. patent applications Ser. Nos. 09/771,514 and 09/771,515, entitled “METHOD AND APPARATUS FOR MANAGING AND ADMINISTERING LICENSING OF MULTI-FUNCTION OFFERING APPLICATIONS” and “METHOD AND APPARATUS FOR MANAGING PUBLICATION AND SHARING DATA” respectively, new approaches to managing and administering licensing of application services to organizations and their users, as well as managing and administering contribution to and usage of shared data are disclosed. In the disclosed new approaches, organizations within an application service delivery environment are characterized based on at least three organization types, service operator organizations, service provider organizations, and service consumer organizations. Service operator organizations may selectively form and license service packages and/or components, as well as data publications of their users to service provider organizations and service consumer organizations. In like manner, service provider organizations may selectively license service packages and/or components as well as data publications of their users to other service provider organizations and service consumer organizations.

Thus, an improved, in particular, an automated approach to application service agreement formation between the organizations is desired.

### BRIEF DESCRIPTION OF DRAWINGS

The present invention will be described by way of exemplary embodiments, but not limitations, illustrated in the accompanying drawings in which like references denote similar elements, and in which:

FIG. 1 illustrates an overview of the present invention, in accordance with one embodiment;

FIG. 2 illustrates a component view of the application service, in accordance with one embodiment;

FIGS. 3a-3c illustrate the relationships between the various entities of the present invention, including the relationships between the different types of organizations, the account creation and administration method of the present invention, and data sharing through publications and subscriptions, in accordance with one embodiment;

FIGS. 4a-4c illustrate properties and methods of a component object, data organization, and security under the present invention, in accordance with one embodiment;

FIG. 5 illustrates a method view of the present invention, in accordance with one embodiment;

FIG. 6 illustrates an approach to organizing offer and acceptance data, in accordance with one embodiment;

FIGS. 7a-7e illustrate the various data objects of FIG. 6 in further detail, in accordance with one embodiment;

FIGS. 8a-8b illustrate an end user interface for creating/updating an offer/counteroffer, and accepting an offer/counteroffer, in accordance with one embodiment;

FIGS. 9a-9b illustrate the relevant operational flows of the automated service agreement tool of FIG. 2, in accordance with one embodiment;

FIG. 10 illustrates an overview of the execution method of the present invention, in accordance with one embodiment;

FIG. 11 illustrates the relevant operational flow of the runtime controller of FIG. 10, in accordance with one embodiment;

FIG. 12 illustrates a network environment suitable for practicing the present invention, in accordance with one embodiment; and

FIG. 13 illustrates an example computer system suitable for use as one of the administrator/user computer of FIG. 12 to practice the present invention, in accordance with one embodiment.

### DETAILED DESCRIPTION OF THE INVENTION

In the following description, various aspects of the present invention will be described. However, it will be apparent to those skilled in the art that the present invention may be practiced with only some or all aspects of the present invention. For purposes of explanation, specific numbers, materials and configurations are set forth in order to provide a thorough understanding of the present invention. However, it will also be apparent to one skilled in the art that the present invention may be practiced without the specific details. In other instances, well known features are omitted or simplified in order not to obscure the present invention.

Parts of the description will be presented using terms such as accounts, IDs, objects, end-user interfaces, buttons, and so forth, commonly employed by those skilled in the art to convey the substance of their work to others skilled in the art. Parts of the description will be presented in terms of operations performed by a computer system, using terms such as creating, empowering, and so forth. As well understood by those skilled in the art, these quantities and operations take the form of electrical, magnetic, or optical signals capable of being stored, transferred, combined, and otherwise manipulated through mechanical and electrical components of a digital system; and the term digital system include general purpose as well as special purpose data processing machines, systems, and the like, that are standalone, adjunct or embedded.

Various operations will be described as multiple discrete steps performed in turn in a manner that is most helpful in understanding the present invention, however, the order of description should not be construed as to imply that these operations are necessarily order dependent, in particular, the order the steps are presented. Furthermore, the phrase “in one embodiment” will be used repeatedly, however the phrase does not necessarily refer to the same embodiment, although it may. The terms “comprising”, “having”, “including” and the like are synonymous.

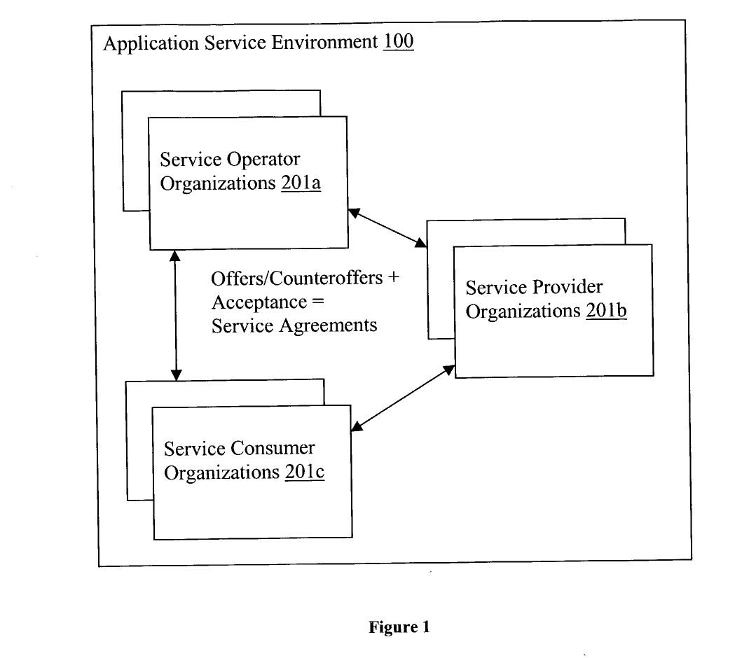

Referring now to FIG. 1, wherein an overview of the present invention in accordance with one embodiment is shown. As illustrated, in accordance with the present invention, organizations 201a-201c in an application service environment 100 are characterized at least as service operator organizations 201a, service provider organizations 201b and service consumer organizations 201c. In alternate embodiments, the present invention may be practiced with more or less organization characterizations.

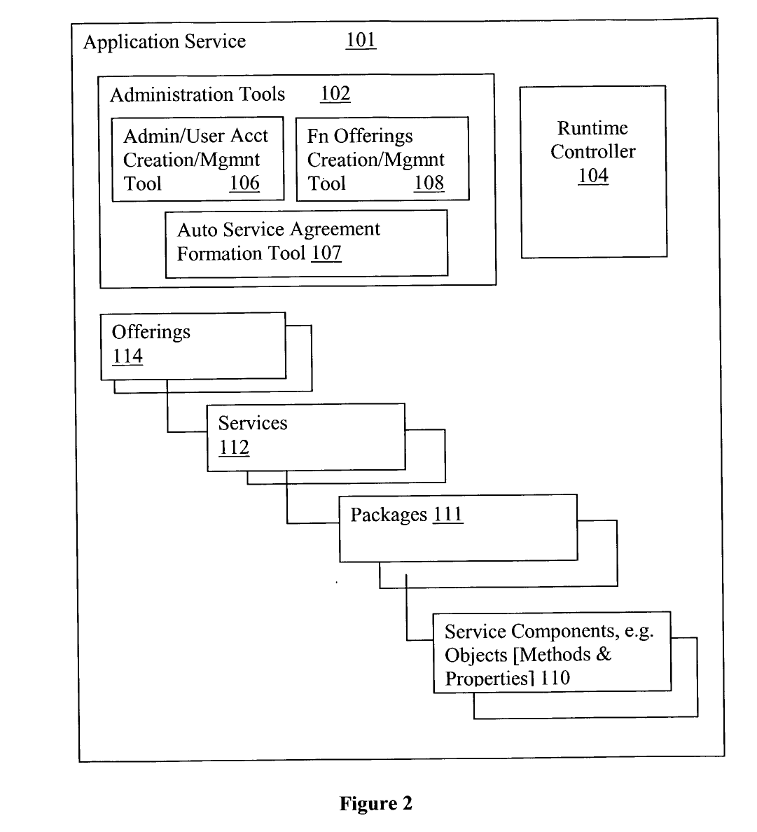

For the purpose of this application, a service operator organization 201a is an organization that operates the hardware, i.e. one or more servers, hosting application or application services (101 of FIG. 2) of environment 100, and licenses all or selected combinations of the functions and services of application to service provider organizations 201b, which in turn may license the licensed functions or services, or selected subsets, to one or more other service provider and/or consumer organizations 201b and 201c. A service consumer organization 201c is an organization of users licensed by a service provider organization 201b to use all or a subset of the functions and/or services of application provided by the service provider organization 201b. For the embodiment, a service operator organization 201a may also act in the role of a service provider organization 201b, i.e. licensing all or a subset of the functions/services of application to one or more service consumer organizations 201c directly.

In accordance with the present invention, application service (110 of FIG. 2) of environment 100 includes in particular, automated service agreement formation tool (107 of FIG. 2). Tool 107 is advantageously equipped to enable application service agreements to be formed in an automated manner between service operator organizations 201a and service provider organizations 201b, between service provider organizations 201b, between service operator organizations 201a and service consumer organizations 201c and between service provider organizations 201b and service consumer organizations 201c, thereby streamlining application service delivery within environment 100.

More specifically, automated service agreement formation tool 107 enables authorized users of a service operator/provider organization 201a/201b to create an offer for one or more service provider/consumer organizations 2011/201c. For the purpose of the present application, the offer extending organization is also referred to as an offeror organization, whereas an offer receiving organization is also referred to as offeree organizations. Further, automated service agreement formation tool 107 enables authorized users of an offeree organization 201a/201b to accept an offer or create a counteroffer to an offer. A counteroffer extending organization is also an offeror organization. A service agreement is formed between an offeror organization and an offeree organization when an offer or counteroffer of an offeror organization is accepted by an offeree organization of the offer or counteroffer.

As will be described in more detail below, in accordance with one embodiment of the present invention, an offer may be created in one of at least three types, a bilateral type, a multilateral type and a unilateral type. An offer of a bilateral type is an offer extended to a singular offeree organization explicitly designated by the offeror organization. An offer of a multilateral type is an offer extended to plural offeree organizations explicitly designated by the offeror organization. An offer of a unilateral type is an offer extended to all organizations. An organization adds itself to the offer to become an offeree organization. In alternate embodiments, the present invention may be practiced with more or less offer types.

FIG. 2 illustrates the application service of environment 100 in further detail, in accordance with one embodiment. As illustrated, in addition to the aforementioned automated service agreement formation too 107, application service 101 (hereinafter, including the claims, simply application) includes a number of service components 110 (or simply components), and is provided with administration tools 102 and runtime controller 104 to facilitate administration and management of user access and usage of components 110. In one embodiment, application 101 is hosted on one or more servers, and the users are remote client users accessing components 110 remotely.

For the illustrated embodiment, as will be described in more details below, components 110 are selectively packaged into packages 111, which in turn are packaged into services 112, and then function offerings 114 for administration and management, i.e. licensing and access/usage control. However, in alternate embodiments, the present invention may alternatively be practiced with more or less levels of organization/packaging of components 110.

For the purpose of this application, components are programmatic software entities commonly referred to as “objects”, having methods and properties, as these terms are well known in the context of object oriented programming. Packages are groupings of interdependent components similar in functional scope. Services are logical groupings of service functionality that when combined with other services provide broader information processing support. Functional offerings are sets of services offered and licensed to licensees. In alternate embodiments, other manners of grouping modules, functions and services may be practiced instead.

Administration tools 102 (in addition to automated service agreement formation tool 107) include in particular account creation/management (ACM) tool 106 and function offering/service creation/management (FCM) tool 108. ACM tool 106 is equipped to facilitate creation of various administrator and end user accounts for various administrators and end users, including facilitation of empowerment of various administrators to administer control on user access to application 101, more specifically, functional offerings 114 and services 112. In one embodiment, the administrator and user accounts are organized by organizations. As described earlier, at least organizations of three types, service operator, service provider and service consumer, are recognized.

In one embodiment, ACM tool 106 is also equipped to facilitate the logical creation of these organizations on the system hosting application 101. FCM tool 108 is equipped to facilitate creation of the various function offerings 114 and services 112, including empowering of the various administrators of the various organizations in administering control on user access to components 110, through invocation of function offerings 114 and/or services 112. In one embodiment, both ACM tool 106 and FCM tool 108 are also equipped to cooperate to facilitate data sharing through publication and subscription.

Before proceeding with additional description, it should be noted that application 101 is intended to represent a broad range of application known in the art, including in particular financial applications such as those offered by the assignee of the present invention. Further, while for ease of understanding, the present invention is presented in the context of application 101, from the description to follow, those skilled in the art would appreciate that the present invention may be practiced for other system/subsystem software products or services, as well as other multi-media contents, including but not limited to video, audio and graphics. Accordingly, unless specifically limited, the term “application” as used herein in this patent application, including the specification and the claims, is intended to include system and subsystem software products and services, as well as multi-media contents.

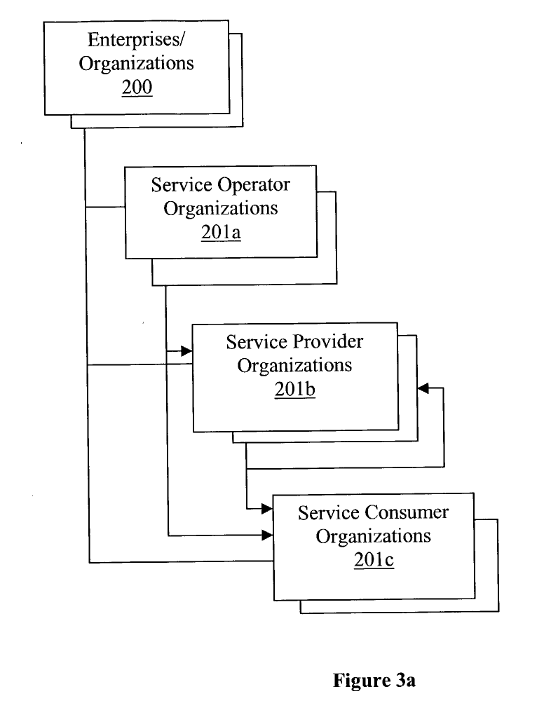

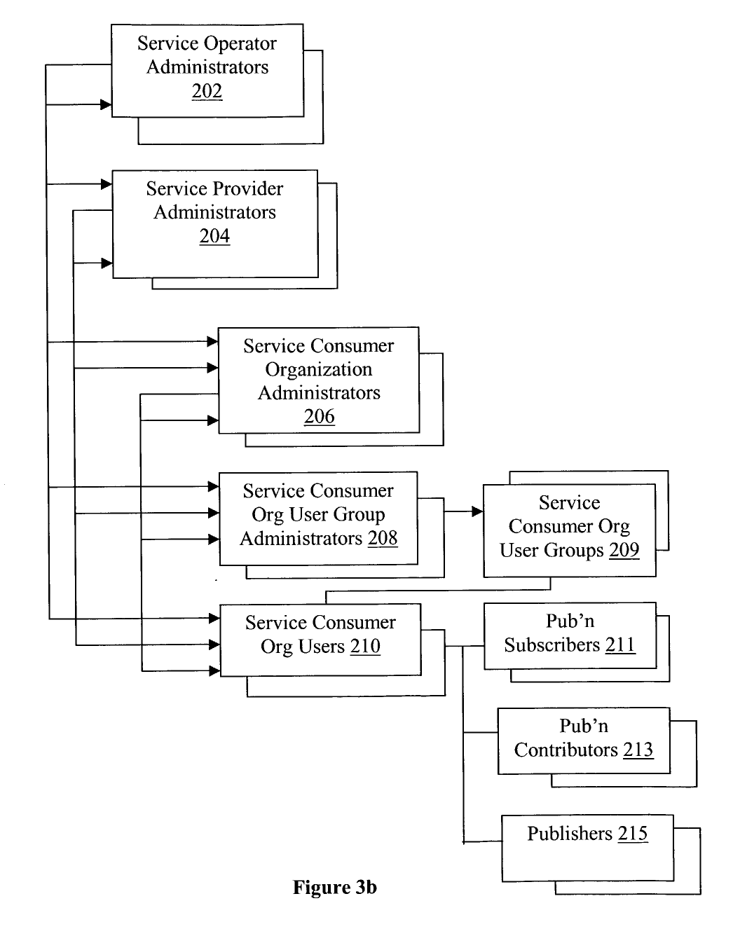

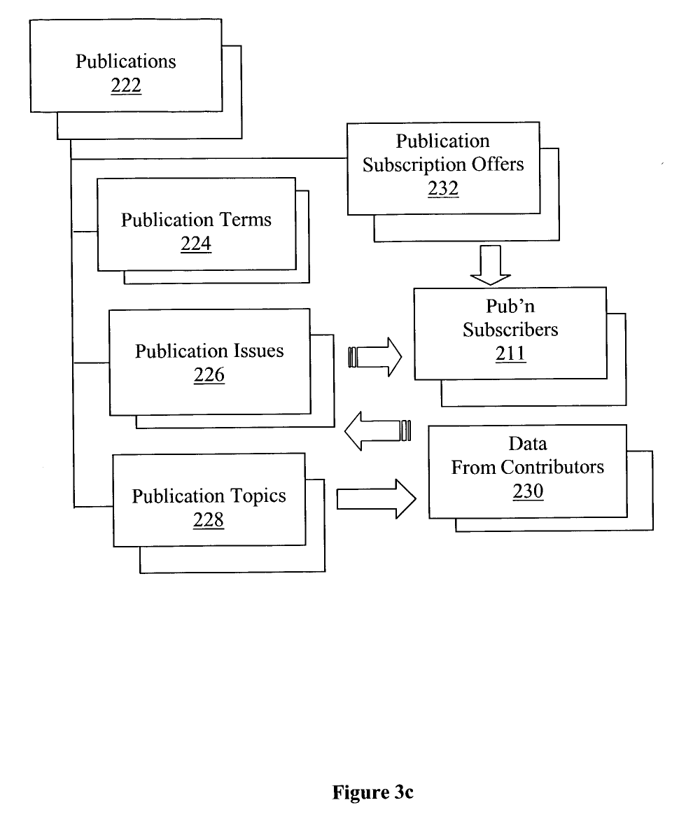

Referring now to FIG. 3a-3c, wherein an overview of the relationship between the various entities under the present invention, including the relationships between the various organizational types, the administrator and user account creation and management method of the present invention, and data sharing through publication and subscription, in accordance with one embodiment, is shown. As illustrated in FIG. 3a and alluded to earlier, for the embodiment, organizations 200 may be classified into one of at least three types, service operator, service provider, and service consumer.

As illustrated in FIG. 3b, for the embodiment, an administrator 202 of a service operator organization creates administrator accounts for administrators of service provider organizations 204. An empowered administrator 202 of a service operator organization may also create administrator accounts for other administrators of the service operator organization. Administrators 202 of the service operator organization also empower administrators 204 of the organization's service provider organizations to further create other administrator and user accounts, and administer control on user access to components 110 of application 101 (through access to functional offerings 114 or services 112).

Continuing to refer to FIG. 3b, an empowered administrator 204 of a service provider organization in turn would create administrator accounts for administrators 206 of service consumer organizations of the service provider organization. Similarly, an empowered administrator 204 of a service provider organization may also create other administrator accounts for other administrators of the service provider organization. An empowered administrator 204 of a service provider organization also empowers administrators 206 of the organization's service consumer organizations to create user accounts for users 210 of the organization's service consumer organizations, and administer control on user access to components 110 of application 101 (through access to functional offerings 114 or services 112) within the respective licensee organizations.

For the illustrated embodiments, service consumer organizations are constituting organization units of licensee enterprises of application 101. Each service consuming licensee enterprise may have one or more physical organization units. Each organization unit may be a wholly owned subsidiary, a division, a group, or a department. In other words, it may be any one of a number of business organizational entities.

Moreover, an empowered administrator 206 of a service consumer organization may also create one or more user groups 209, associates users 210 as members of user groups 209, as well as creating group administrator accounts for user group administrators 208 of the service consumer organization. Similarly, in alternate embodiments, the present invention may also be practiced without the employment of user groups or with more levels of user organizations.

Note that an administrator is also a “user”, only a special “user”, having assumed the role or responsibility of administration. Similarly a service operator or a service provider is also an “enterprise”, only a special “enterprise”, having assumed the role or responsibilities described above for a service operator and a service provider respectively. Moreover, each service operator, as well as each service provider, may have its own “organization” administrators, user groups and users. However, for ease of understanding, the present invention will be described using these terms delineating the roles assumed by the different enterprises/users. Further, the present invention will only be described in terms of a service operator delegating and empowering a service provider, and an empowered service provider in turn delegating and empowering administrators of a service subscribing licensee service consumer organization, and so forth. Those skilled in the art would appreciate that the description applies equally to the service operator/provider's own organization administrator,-user groups and end users.

In one embodiment, an empowered administrator 202 of a service operator organization is also able to create the administrator accounts and the end user accounts of a service consumer organization directly, skipping the creation and licensing of a service provider organization, or one or more of the administrators 204 of the organization's licensed service provider organizations, and in the case of user accounts, the administrators 206 of the service consumer organizations. Similarly, an empowered administrator 204 of a service provider organization is also able to create user group administrators 208, user groups 209, and end user accounts for users 210 of a service consumer organization directly, skipping administrators 206 of the organization's service consumer organization. In other words, for the illustrated embodiment, an administrator 202 of a service operator organization may perform all administration and management tasks an administrator 204 of a service provider organization of its creation, as well as an administrator 206 of a service consumer organization of the service provider organization may perform. An administrator 204 of a service provider organization may perform all administration and management tasks an administrator 206 of a of a service consumer organization of its creation may perform.

Thus, it can be seen from the above description, under the present invention, the administration and management of licensing, i.e. logical creation of the organizations, creations of the administrator/user accounts, control of user access to an application, is advantageously hierarchical and decentralized, with the administration responsibilities distributable/delegatable to administrators at various levels of the administration hierarchy. Experience has shown, the hierarchical decentralized or distributed approach is much more flexible, and particular suitable for administering and managing licensing of applications with complex multi-functions, to a large customer base with a large number of end users, across large wide area networks.

Still referring to FIG. 3b, as illustrated, to facilitate data sharing between users of the same and different organizations 210a-210c in a controlled manner, administrators 202-206 of the various organizations 201a-201c may also authorize selected users 210 subject to their administration, to be publishers 215 of data publications 222, data contributors 213 to data publications 222 (if permitted by the owner users 215 of the data publications 222), and/or data subscribers 211 to data publications 222 (also if permitted by the owner users 215 of the data publications 222).

As illustrated in FIG. 3c, a data publisher 215 may create and manage one or more data publications 222, thereby becoming the owner user of the data publications 222. A data publisher user 215 may specify the terms 224 of the data publications 222, such as, the frequency of publication (e.g. weekly, bi-weekly, monthly, and so forth), resulting in the data publications 222 having different publication issue instances 226, and the cost of subscription.

A data publisher user 215 may also specify and authorize one or more other users 210 to contribute their data to selected ones of the data publisher user's data publications 222 (provided the authorized contributor users 213 are also authorized by his/her administrators 202-206 to contribute their data to other users' data publications 222). In other words, under the present invention, a data publication 222 may contain data from the owner publisher user 215 as well as data from non-owner contributor users 213. Moreover, data contribution by non-owner contributor users 213 are subject to the control of the owner of the data publication 222 as well as the administrators 202-206 with administration power over the potential non-owner contributor users 213 authorized by the owner publisher user 215.

A data publisher user 215 may also specify the publication topic 228 of a data publication 222, thereby controlling the nature of the data contributable to the data publication 222.

Further, an administrator of a service consumer organization 210c (or its licensor service operator/provider organization 201a/201b) may also create publication subscription offers 232 to offer data publications 222 for subscription by users of the organization 201c. Authorized users 210 in turn may subscribe to offered publications 232 of interest. That is, under the present invention, data subscriptions are subject to the control of the administrators 202-206, on who may subscribe to data publications 222 as well as what data publications 222 can be subscribed.

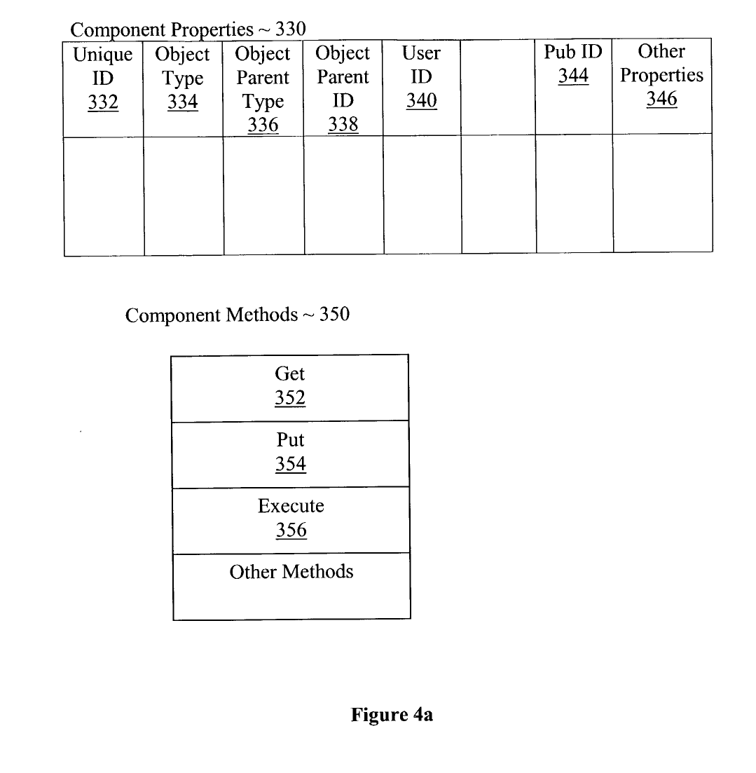

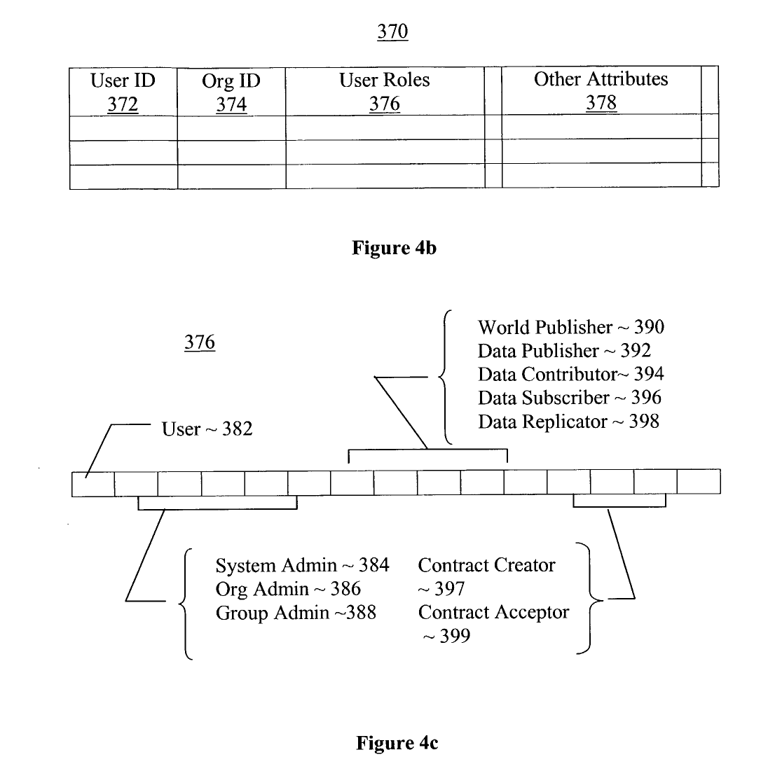

FIG. 4a illustrates in further detail the properties of a component 110, and its methods. As illustrated in FIG. 4a, for the embodiment, each component 110 includes a unique identifier 332 identifying the component, and a type property 334 to identify the object type of the component. Further, each component 110 includes properties 338 and 336 describing the parent object's identifier and the object type of the parent object respectively. Additionally, each component 110 includes property 340 identifying the user owner, and if applicable, property 344 identifying the data publication with which the component is associated with. As illustrated, component 110 may also include other properties 346.

As alluded to earlier, each component 110 has a number of methods. For the illustrated embodiment, the methods 350 include at least a Get method 352 for retrieving data associated with the component and other applicable subscribed publishing components, a Put method 354 to store a copy of data present in the component into memory or mass storage, and an Execute method 356 to perform a pre-determined computation using the data of the component and other applicable subscribed publishing components. Of course, each component 110 may also include other methods.

FIGS. 4b-4c illustrate a security arrangement, in accordance with one embodiment of the present invention. As illustrated in FIG. 4b, the organization identifier 374 of the organization to which a user is a member is tracked. For the embodiment, each organization is typed, as earlier described. Further, the organization types are tracked (not shown). Accordingly, based on the tracked organization identifier 374 of an organization, the organization type of the organization to which a user is a member may be determined.

Additionally, the various user roles 376 a user may operate in, as authorized by the administrators with administrative power over the user, are also tracked. In one implementation, as illustrated in FIG. 4c, all users are authorized to use the functions/services of application 101 authorized for its user group (which may be all or a subset of the functions/service of application 101 licensed to the user's organization) as a user. Additionally, each user may be optionally authorized to operate in a group administrator role 388 for its user group, an organizational administrator role 386 for its organization, and/or a system administrator role 384 (if the user is a member of a service operator or service provider organization). Further, each user may be optionally authorized to operate in a publisher role 392 publishing data publications, a contributor role 394 contributing data to data publications, and/or a subscriber role 396 subscribing to data publications,.

In one implementation, for efficiency of administration, a user may also be optionally authorized to operate in a world publisher role 390, whose data publications may be subscribed by any user of any organization.

Further, for the embodiment, a user may optionally be authorized to operate in a contract creator role 397, and/or contract acceptor role 399. A user authorized to operate in the contract creator role 397 may create and extend an offer or a counteroffer on behalf of his/her organization. A user authorized to operate in the contract acceptor role 399 may on behalf of his/her organization, accept an offer or a counteroffer, to form a service agreement with the offeror organization.

In one embodiment, the authorized user roles are tracked in a multi-value user role variable.

For the embodiment, security is enforced in accordance with these authorized user roles. That is, only users authorized to operate as group administrators may administer the corresponding user groups, only users authorized to operate as organization administrators may administer the corresponding organizations, only users authorized to operate as system administrators may administer the corresponding service operator/provider and their descendant organizations. Only users authorized to operate as publishers (or world publisher)) may publish data publications, only users authorized to operate as contributors may tag and contribute their data to data publications (as authorized by the owners of the data publications), and only users authorized to operate as subscribers may subscribe to offered data publications. Lastly, only users authorized to operate in the contract creator role may create a service offer or counteroffer, and only users authorized to operate in the contract acceptor role may accept a service offer or counteroffer.

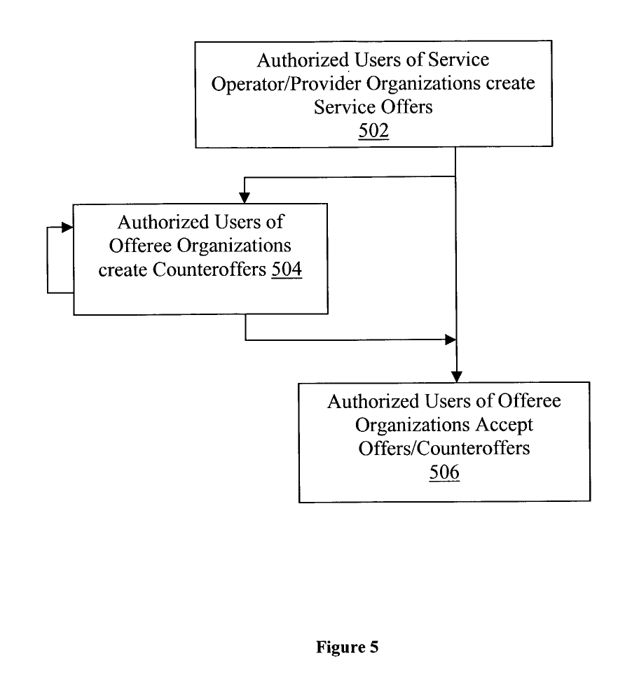

FIG. 5 illustrates a method view of the present invention, in accordance with one embodiment. As illustrated, for the embodiment, an authorized user (administrator) of a service operator/provider administrator, using automated service agreement formation tool 107 (hereinafter “contracting” tool 107), creates an offer for a set of functions, services, components and/or data publications, block 502. The authorized user/administrator, using “contracting” tool 107, specifies various attributes that define the offer. In particular, the authorized user/administrator specifies whether the offer is to be a bilateral offer, a multilateral offer or a unilateral offer. In the former two cases, the authorized user/administrator also specifies the recipients of the offer, i.e. the service provider/consumer organizations to which the offer is extended.

In one embodiment, the authorized user/administrator, using “contracting” tool 107, may also specify basic attributes such as date of the offer, place of the offer and legal jurisdiction which law governs any application service agreement formed based on the offer. In one embodiment, the identifications of the authorized user/administrator and his/her organization are automatically included into the offer by “contracting” tool 107.

In one embodiment, the authorized user/administrator, using “contracting” tool 107, may also specify the various offered items, i.e. service packages, service components and/or data publications. In one embodiment, the authorized user/administrator, using “contracting” tool 107, may also specify the duration and the amount of compensation for any service agreement formed based on the offer.

In one embodiment, the authorized user/administrator, using “contracting” tool 107, may also explicitly specify the completion of the creation of the offer, making the offer available for counter or acceptance. In one embodiment, the authorized user/administrator, using “contracting” tool 107, may also specify termination of any open offer.

In alternate embodiments, the present invention may be practiced with more or less offer attributes.

Still referring to FIG. 5, in response, while an offer is open, an authorized user/administrator of an offeree organization (e.g.. a service provider or a service consumer organization), using “contracting” tool 107, may create a counteroffer to the offer, block 504, or accept the offer/counteroffer as extended, block 506. For the purpose of this application, once created, from a termination and acceptance perspective, a counteroffer is the same as an offer, except a counteroffer is by definition a bilateral offer, in that it is extended only to the original offeror organization of the offer being countered.

In one embodiment, the state of an offer, i.e. whether it is eligible to be counter or accepted, as well as whether the user is an authorized contract creator/acceptor and whether the organization is an offeree organization of the offer are all automatically checked by “contracting” tool 107 before an offer may be countered or accepted.

In the case of a unilateral offer, an authorized user/administrator of an organization uses “contracting” tool 107 to add the organization as a recipient of the offer, making the organization an offeree organization, before either creating a counteroffer or accepting the offer as extended.

Note that as illustrated by the “arrow” disposed at the left hand side of block 504, under the present invention, until an offer/counteroffer is terminating by the offeror organization, the process of counteroffer may in theory continue “indefinitely” subject only to the resources or other operational criteria of environment 100.

Accordingly, it can be seen that the process of application service agreement formation is streamlined for application service environment 100.

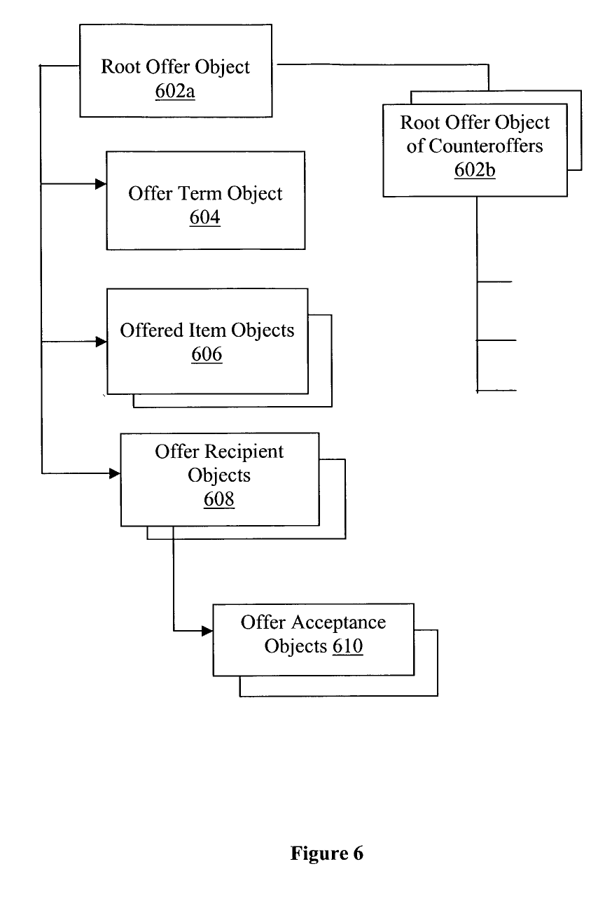

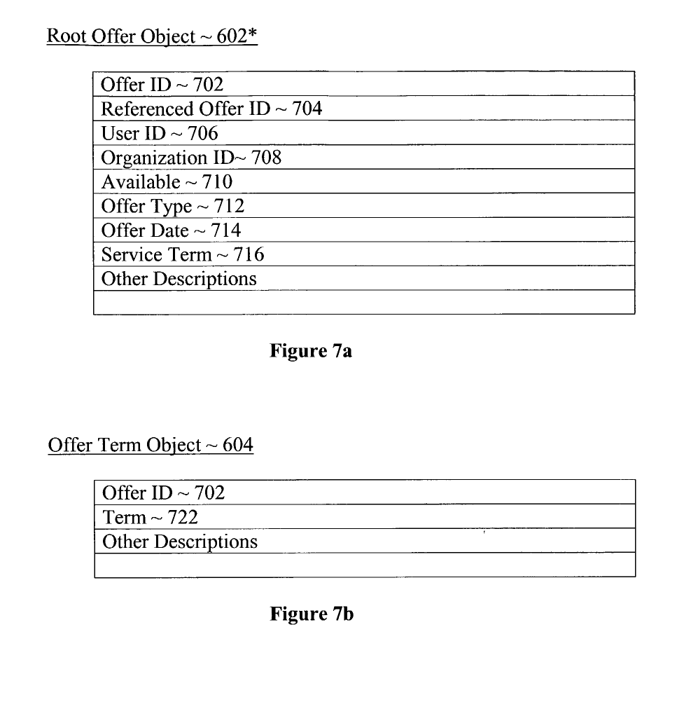

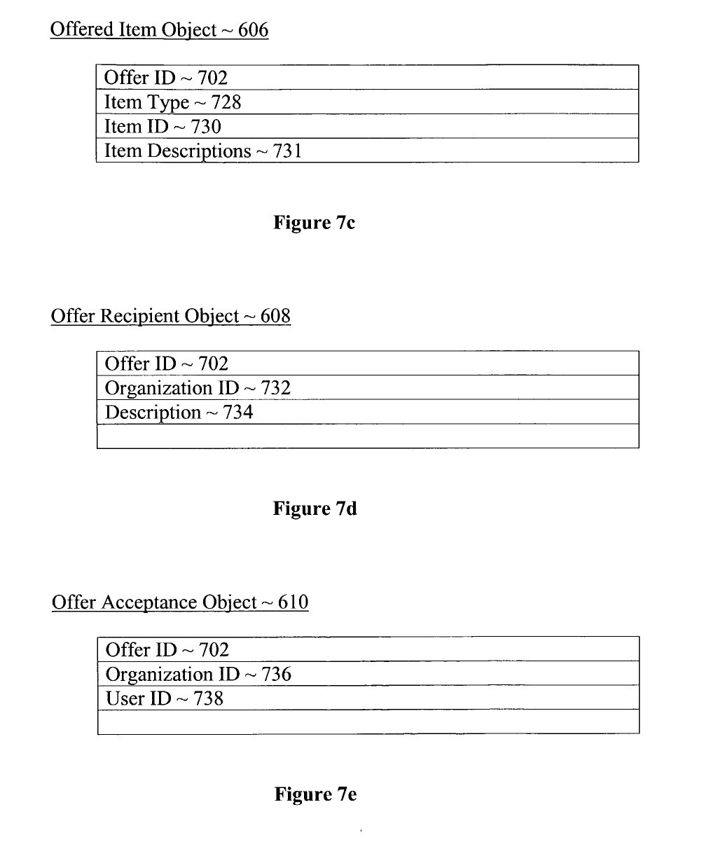

FIG. 6 and FIGS. 7a-7e illustrate an approach to organization the offer and acceptance data, in accordance with one embodiment. As illustrated, for the embodiment, the offer and acceptance data are organized in an object oriented manner, with the basic attribute of an offer being stored in a root offer data object 602a, certain offer term attributes being stored in an offer term data object 604, attributes specifying the offered items stored in corresponding offered item data objects 606, and attributes specifying the recipients (i.e. offeree organizations) stored in corresponding offer recipient data objects 608. Data objects 604-608 are organized as children objects to the root offer data object 602a.

Examples of basic attriibutes stored in the root offer data object 602a are the earlier described identification of the authorized user/administrator creating the offer 706, the offeror organization 708, the offer type 712, the offer date 714, the service term 716 (used for specifying e.g. the offer place, legal jurisdiction and so forth), and whether the offer is still open or terminated 710.

Examples of offer term attributes are terms 722 (usable to specify e.g. the earlier described duration and amount of compensation) for any application service agreement eventually formed based on the offer. Examples of offered item attributes are offered item type 728, service package, component and publiction identifications 730 and their descriptions 731. Examples of offer recipient attributes are identification and description of the offeree organizations 732-734.

Still referring to FIG. 6 and FIGS. 7a-7e, for the embodiment, attributes specifying acceptance of the offer are stored in offer acceptance data objects 610. Offer acceptance data objects 610 are organized as corresponding child objects of offer recipient data objects 608. Examples of offer acceptance attributes are identification of the accepting offeree organization 736 and the authorized user 738 specifying the acceptance. In other embodiments, an offer acceptance data object 610 may also include attributes specifying data of acceptance, place of acceptance and so forth.

As described earlier, an offer may be countered, and a counteroffer is essentially a “new” offer except that it is “derived” from an earlier offer or counteroffer. For the embodiment, data associated with a counteroffer is similar organized into a set of data objects as earlier described for an original offer. However, as opposed to being standlone on their own, the data objects of a counteroffer are organized as children data objects of the parent offer, more specifically, with the root data object 602b of a counteroffer organized as a child data object of the root data object 602a of the parent offer, and the other data objects of the counteroffer descend there from.

For the embodiment, an identification 702 is also automatically assigned to each offer and counteroffer. Identification 702, as illustrated, is stored in each of the earlier described data objects 602a-610. Further, for the embodiment, the parent offer id 704 is also stored in the root offer data object 602 of a counteroffer.

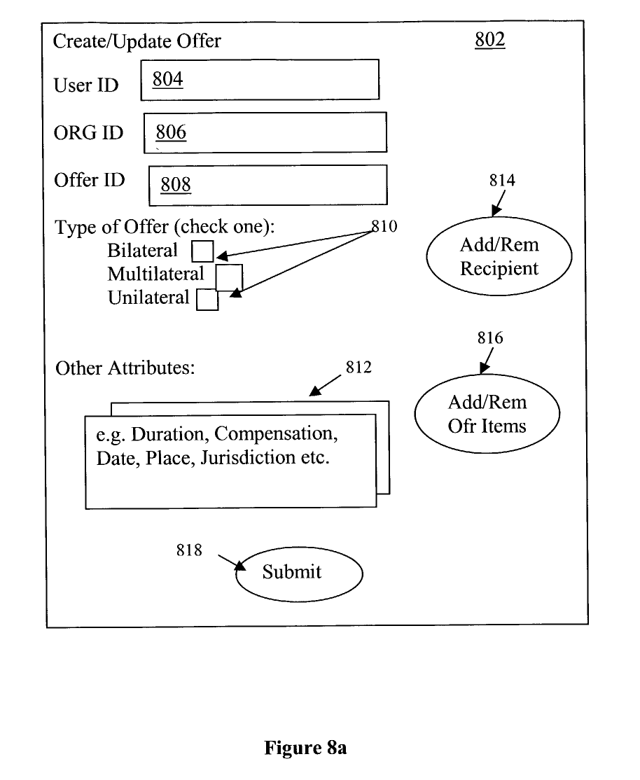

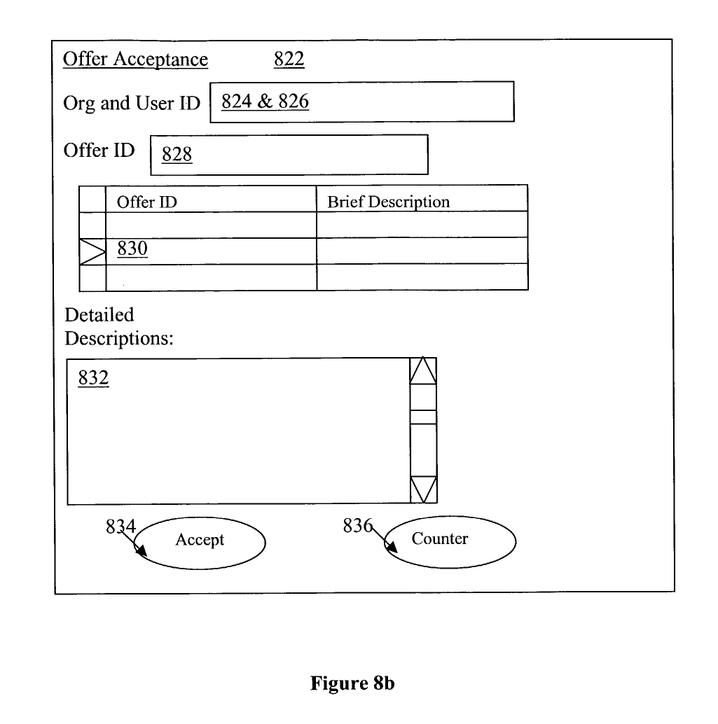

FIGS. 8a-8b illustrate two exemplary panes of an end user interface of “contracting” tool 107 suitable for use to practice the present invention, in accordance with one embodiment. For the illustrated embodiment, the interface includes in particular an offer creation/update pane 802 and an offer acceptance pane 804. For ease of understanding, the description of exemplary offer and acceptance panes 802 and 804 to follow, assumes that the authorized user/administrator has successfully logged into the system (e.g. from a remote administration “console”). That is, the user/administrator has been properly validated as being a user authorized to perform the offer/counteroffer creation or acceptance operation. Such validation may be made in any one of a number of techniques known in the art.

As illustrated, exemplary offer pane 802 includes user and organization identification fields 804 and 806 for displaying user and organization identifiers identifying the authorized user/administrator and his/her organization performing the offer creation or update operation. Offer pane 802 also includes field 808 for the display or entry of an offer identifier for the offer being created or updated, and boxes 810 for denoting the offer type, i.e. bilateral, multilateral or unilateral, as earlier described. Offer pane 802 also includes button 814 for triggering a “pop up” (not shown) for the specification of the recipient organizations, in the event the offer type is either bilateral or multilateral.

Further, offer pane 802 also includes a number of other fields 812 (not particularized) for entry of other attributes, such as the earlier described date of offer, place of offer, legal jurisdiction, duration of agreement, compensation and so forth. Offer pane 802 also includes a number of buttons for invoking additional “pop-ups” to facilitate such entries, including in particular, button 816 for invoking a “pop-up” for specifying the offered items, i.e. service packages, components, and data publications, and button 818 for “submitting” the newly created or modified offer for persistent storage.

As illustrated, exemplary acceptance pane 822 also includes user and organization identification fields 824 and 826 for displaying user and organization identifiers identifying the authorized user/administrator and his/her organization performing the offer acceptance operation. Further, acceptance pane 822 includes a list of currently open offers extended to the offeree organization, available for the authorized user/administrator to accept or counter. Acceptance pane 822 also includes description field 832 enumerating the various attribute values specifying the offer, such as earlier described offered item attributes, duration, compensation and so forth.

Acceptance pane 822 also includes a number of buttons, in particular, button 834 for the authorized user/administrator to denote acceptance of the offer on behalf of the offeree organization, and button 836 for invoking earlier described pane 802 to create a counteroffer to the offer.

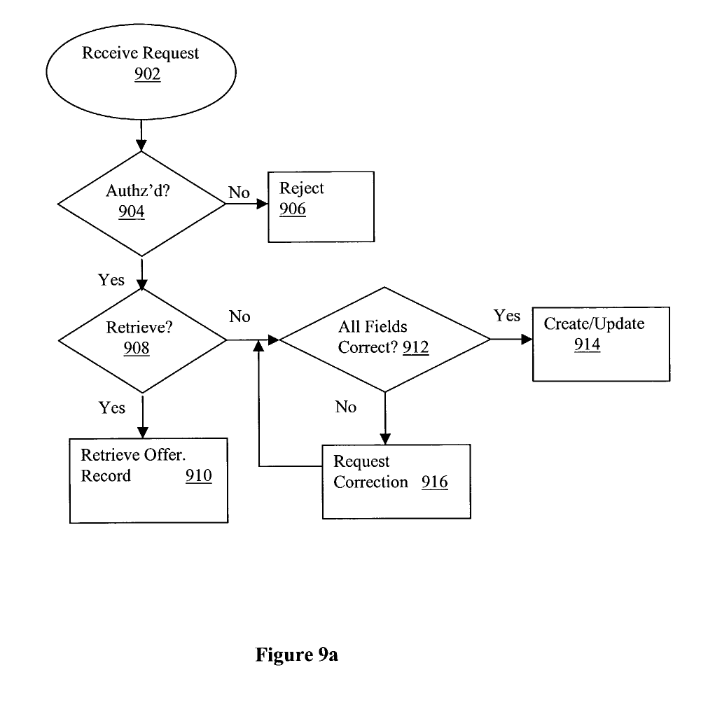

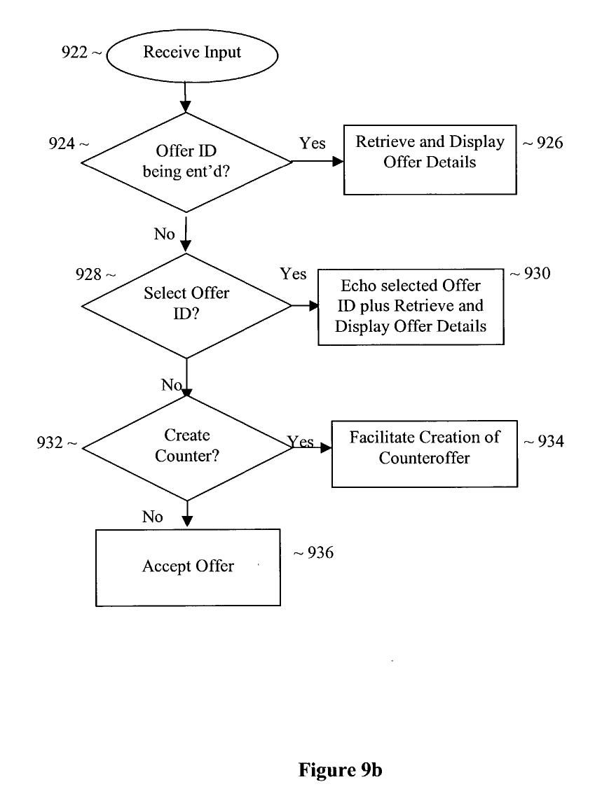

FIGS. 9a-9b illustrate the relevant operational flows of “contracting” tool 107 for practicing the present invention, in accordance with one embodiment. More specifically, FIG. 9a illustrate the relevant operational flow of “contracting” tool 107 in support of exemplary offer pane 802, whereas FIG. 9b illustrate the relevant operational flow of “contracting” tool 107 in support of exemplary acceptance pane 822.

As illustrated in FIG. 9a, upon receipt of an event notification associated with offer pane 802 (hereinafter, simply “request”), “contracting” tool 107 determines if the requested operation is authorized or not, block 904, that is whether the logged-in user/administrator is empowered to perform the requested offer creation/update operation (e.g. in the earlier described embodiment where user roles are tracked in a multi-value user role variable, checking whether the corresponding contract creator role value of the user role variable is set). If not, the requested operation is rejected, block 506, preferably with appropriate rejection notification messages.

If the requested operation is authorized, tool 107 determines whether the request is to retrieve an existing offer (e.g. as indicated by the entry of an offer identifier by the authorized user/administrator), block 908. If so, “contracting” tool 107 retrieves the identified offer as requested (e.g. retrieving attribute values from the earlier described offer data objects), block 910.

If it is determined at block 908 that the requested operation is not a retrieval request, the requested operation is either an update or create request. Contracting tool 107 then proceeds to verify whether all required fields have been properly entered, and whether all entered fields have been entered correctly with the appropriate type of information. The precise nature of error checking is application dependent, and not essential to the practice of the present invention. If one or more errors are detected, correction is requested of the user, block 916. Eventually, upon determining that all fields are correct, “contracting” tool 107 creates or updates the offer as requested (e.g. creating or updating the earlier described offer data objects), block 920.

Similarly, as illustrated in FIG. 9b, for the embodiment, upon receipt of an event notification associated with exemplary acceptance pane 822 (hereinafter, also simply “request”), block 922, “contracting” tool 107 determines if the request is associated with an offer identifier being entered, block 924. If so, “contracting” tool 107 retrieves and displays the descriptions the requested offer (i.e. all or a subset of the defining attributes of the offer), block 926. If not, “contracting” tool 107 continues at block 928.

At block 928, “contracting” tool 107 determines if the request is associated with the selection of a displayed open offer. If so, “contracting” tool 107 echoes the offer identifier of the selected offer in the offer identifier field, as well as retrieving and displaying the descriptions the selected offer as earlier described, block 930.

At block 932, “contracting” tool 107 determines if the request is associated with creation of a counteroffer or acceptance of the selected offer. If the request is associated with creation of a counteroffer, execution control is transfer to the portion of “contracting” tool 107 in support of such operation, block 934. However, if the request is associated with acceptance of the selected offer, “contracting” tool 107 facilitates acceptance of the offer (e.g. facilitating creation of the earlier described acceptance data object), block 936.

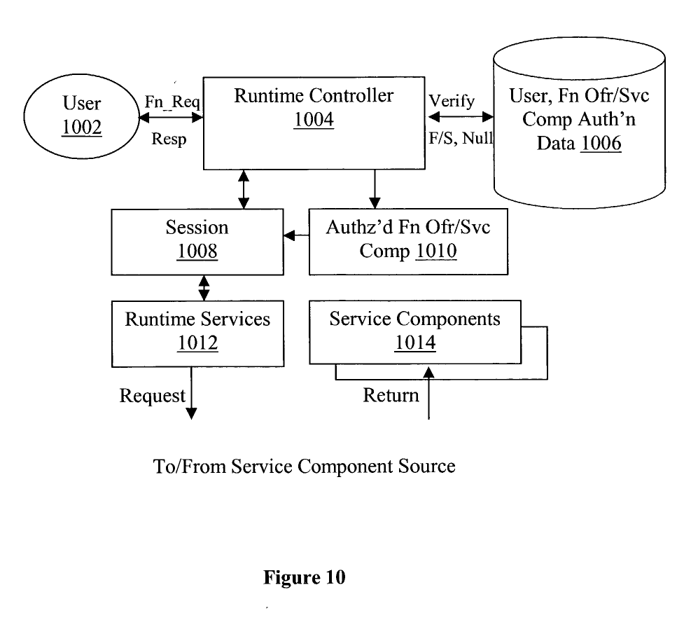

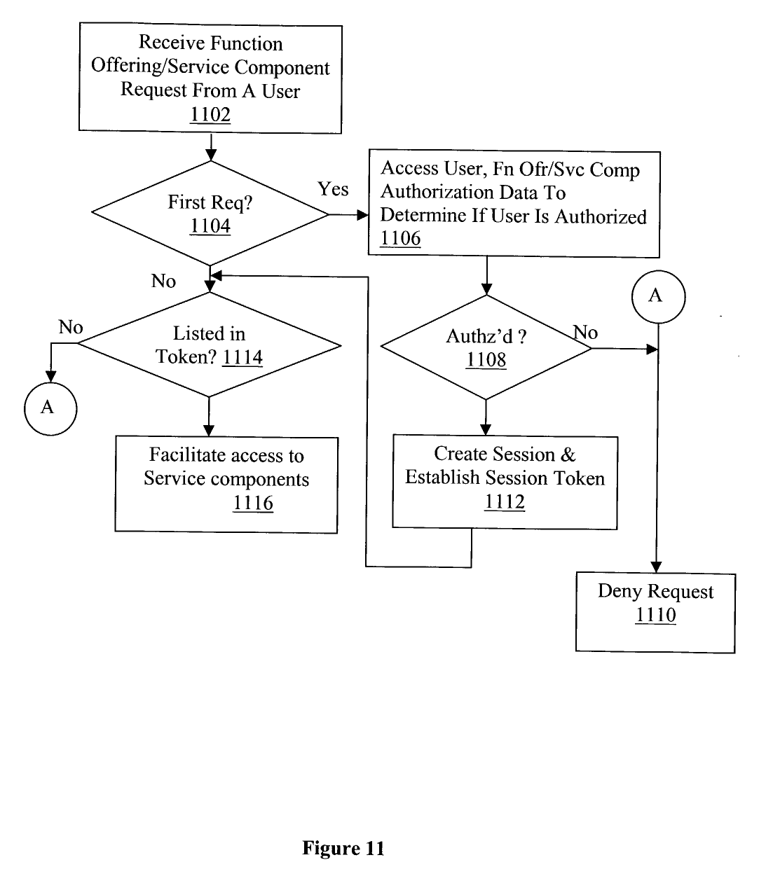

FIGS. 10 and 11 illustrate an overview of a function offering or service launching method of the present invention, in accordance with one embodiment. As illustrated, user 1002 submits a function request (Fn_Req) to runtime controller 1004 (same as runtime controller 104 of FIG. 1) (block 1102). In response, runtime controller 1004 determines if this is the first request from user 1002, i.e. whether a session environment has previously been created for requesting user 1002 (block 1104). If the request is the first request and the session environment is yet to be created, runtime controller 1004 accesses users and function offerings/services authorization database 1008 to verify user 1002 is “enabled”, i.e. authorized to access at least one service or function offering (blocks 1106 and 1108). In one embodiment, if user is “enabled”, runtime controller 1004 also accesses users and function offerings/services authorization data 1008 to determine if the user is an eligible shared data publisher, contributor, and/or subscriber, and if so, the applicable data publications, if any. Users and function offerings/services authorization data 1008 includes a data organization having user, function offering/service authorization and enabling information, and components 110 having multi-value user variable 376 as earlier described referencing FIG. 4c. Further, in an embodiment where data sharing through publication and subscription of data publications, as earlier described is supported, data 1008 further includes the applicable data publications published, contributed or subscribed by the user.

If user 1002 is not “enabled” (authorized) to access at least one service or function offering (nor any shared data), the request is rejected or denied (block 1110). If user 1002 is “enabled” (authorized) to access at least one service or function offering (or at least some shared data), runtime controller 1004 establishes a session environment 1008 for the user, instantiates various runtime services 1012 for the session 1008, retrieves a token 1010 listing all the authorized function offerings and services of the user, and associates token 1010 with session 1008 (block 1112). In an embodiment where data sharing through publication and subscription is supported, token 1010 further includes identification of the applicable data publications and/or replication items, if any. For the earlier described publication and subscription approach, applicable ones of the data publications are resolved through the properties of the data publications and related objects.

Upon doing so, or earlier determining that the request is not a first request, and such a session environment had been previously established for the user, runtime controller 1004 transfers the request to an appropriate runtime service to handle (e.g. the earlier described replicate request to a replicate service). Thereafter, runtime services 1012 retrieve and instantiate the appropriate service components or objects associated with the requested service or applicable services associated with the requested function offering 1014 in accordance with whether the requested services/function offerings are among the authorized ones listed in token 1010 created for the session 1008. Further, during execution, the user is conditionally given access to use the earlier described Get, Put, and Execute method associated with the “authorized” service components, depending on whether the user has been given the right to access these methods (blocks 1114-1116). Recall a non-user owner is implicitly given the right to use these methods, for being a member of an authorized user group of the user owner, or a fellow user of the authorized organization/enterprise of the user owner. Alternatively, the non-user owner may have been implicitly given the right to use these methods because the user has been authorized to operate in certain user roles.

Moreover, in an embodiment where data sharing through publication and subscription as earlier described is supported, an authorized user is given access to contribute or retrieve data of the applicable data publications. In the presently preferred embodiments, a contributor contributes data to a data publication by tagging the contributing data to the target data publication. Tagging of contributing data to the target data publications result in their association (and not actual copying of the contributing data into the data publication). The data content of a data publication is coalesced together when it is accessed or retrieved by a data subscriber.

Runtime services 1012 are intended to represent a broad range of runtime services, including but are not limited to memory allocation services, program loading and initialization services, certain database or data structure interfacing functions, and so forth. In alternate embodiments, security token 1010 may be statically pre-generated and/or dynamically updated to reflect dynamic changes in publications and subscriptions.

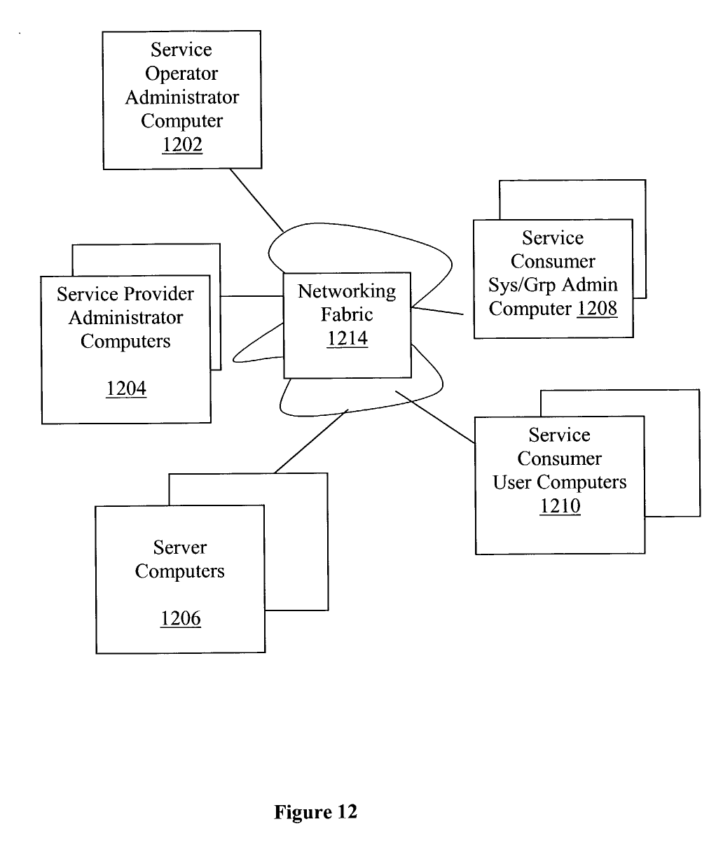

FIG. 12 illustrates a network environment suitable for practicing the present invention. As illustrated, network environment 1200 includes service operator administrator computer 1202, service provider administrator computers 1204, server computers 1206, organization administrator computers 1208, and end user computers 1210. The computers are coupled to each other through networking fabric 1214.

Server computers 1206 are equipped with the earlier described multi-function application 101 including administration tool 102 and runtime controller 104. In selected implementations, all or part of ACM 106 and FOM 108 are instantiated onto the respective computers 1202-1204 and 1208-1210 for execution. Similarly, for selected ones of function offerings 114, services 112, packages 111 or service components 110, all or part of these offerings, services, packages or service components are invoked by end user computers 1212 for execution.

In one embodiment, service operator administrator computer 1202, service provider administrator computers 1204 and server computer 1206 are affiliated with the vendor of application 101, while organization administrator computers 1208, and end user computers 1210 are affiliated with customers or service subscribers of application 101.

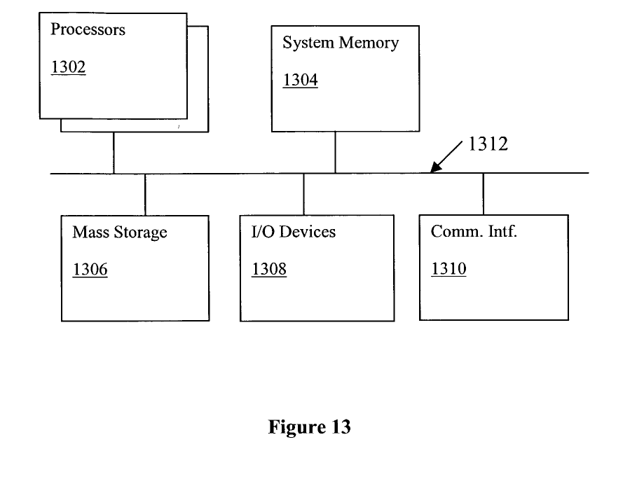

Computers 1202-1210 are intended to represent a broad range of computers known in the art, including general purpose as well as special purpose computers of all form factors, from palm sized, laptop, desk top to rack mounted. An example computer suitable for use is illustrated in FIG. 13. Networking fabric 1214 is intended to represent any combination of local and/or wide area networks, including the Internet, constituted with networking equipment, such as hubs, routers, switches as the like.

As alluded to earlier, FIG. 13 illustrates an example computer system suitable for use to practice the present invention. As illustrated, example computer system 1300 includes one or more processors 1302 (depending on whether computer system 1300 is used as server computer 1206 or other administrator/end user computers 1202-1204 and 1208-1210), and system memory 1304 coupled to each other via “bus” 1312. Coupled also to “bus” 1312 are non-volatile mass storage 1306, input/output (I/O) devices 1308 and communication interface 1314. During operation, memory 1304 includes working copies of programming instructions implementing teachings of the present invention.

Except for the teachings of the present invention incorporated, each of these elements is intended to represent a wide range of these devices known in the art, and perform its conventional functions. For example, processor 1302 may be a processor of the Pentium® family available from Intel Corporation of Santa Clara, Calif., or a processor of the PowerPC®) family available from IBM of Armonk, N.Y. Processor 1302 performs its conventional function of executing programming instructions, including those implementing the teachings of the present invention. System memory 1304 may be SDRAM, DRAM and the like, from semiconductor manufacturers such as Micron Technology of Boise, Idaho. Bus 1312 may be a single bus or a multiple bus implementation. In other words, bus 1312 may include multiple buses of identical or different kinds properly bridged, such as Local Bus, VESA, ISA, EISA, PCI and the like.

Mass storage 1306 may be disk drives or CDROMs from manufacturers such as Seagate Technology of Santa Cruz of CA, and the like. Typically, mass storage 1306 includes the permanent copy of the applicable portions of the programming instructions implementing the various teachings of the present invention. The permanent copy may be installed in the factory, or in the field, through download or distribution medium. I/O devices 1308 may include monitors of any types from manufacturers such as Viewsonic of Walnut, Calif., and cursor control devices, such as a mouse, a track ball and the like, from manufacturers such as Logictech of Milpitas, Calif. Communication interface 1310 may be a modem interface, an ISDN adapter, a DSL interface, an Ethernet or Token ring network interface and the like, from manufacturers such as 3COM of San Jose, Calif.

Thus, a method and an apparatus for facilitating automated service agreement formation for multi-function offering applications have been described. While the present invention has been described in terms of the above illustrated embodiments, those skilled in the art will recognize that the invention is not limited to the embodiments described. The present invention can be practiced with modification and alteration within the spirit and scope of the appended claims. The description is thus to be regarded as illustrative instead of restrictive on the present invention.

What is claimed is:

1. In an application service environment, a computer assisted method for forming an application service agreement between a first and a second organization, the method comprising:
facilitating an authorized user of the first organization in creating an offer to form said application service agreement, with the offer comprising first one or more offer data object instances having first one or more attributes describing the offer, and the first one or more offer data object instances having association with one or more methods for an authorized user of the second organization to accept the offer or create a first counter offer to the offer; and
facilitating an authorized user of the second organization using the first one or more methods to perform one of
a) accepting the offer,
b) creating a first counter offer to the offer, with the first counter offer comprising second one or more offer data object instances, derived from the first one or more offer data object instances, having second one or more attributes describing said first counter offer, and the second one or more offer data object instances also having association with the one or more methods for an authorized user of the first organization to use to accept the first counter offer or create a second counter offer to the first counter offer.

2. The method of claim 1, wherein said facilitating of an authorized user of the first organization in creating said offer comprises facilitating an authorized user of the first organization in creating a first root offer data object instance having first one or more basis attributes defining basic aspects of the offer, with the first root offer data object instance having association with one or more methods for an authorized user of the second organization to accept the offer or create the first counter offer to the offer.

3. The method of claim 2, wherein the first one or more basis attributes include an offer type attribute specifying an offer type of the offer, that is selected from an offer type group having at least one of
a) a bilateral offer type denoting singular extension of an offer to a particularized organization of the application service environment,
b) a multilateral offer type denoting particularized plural extensions of an offer to a number of enumerated organizations of the application service environment, and
c) a unilateral offer type denoting general plurality extensions of an offer to all organizations of the application service environment.

4. The method of claim 3, wherein the method further comprises facilitating an authorized user of the first organization in creating an offer recipient data object instance that is a child data object instance to said first root offer data object instance, with one or more attritbues specifying one or more organizations to which the offer is extended, when the offer type is one of the bilateral and the multilateral type.

5. The method of claim 4, wherein the method further comprises facilitating an authorized user of the second organization in creating an offer recipient data object instance that is a child data object instance to said first root offer data object instance, with one or more attritbues specifying the second organization as an organization to which the offer is extended, when the offer type is an unliteral type.

6. The method of claim 2, wherein said facilitating of an authorized user of the first organization in creating the first root offer data object instance further comprises faciliating an authorized user of the first organization in specifying one or more of an offer date, an offer place, and a choice of law governing any application service agreement resulted from said offer, via one or more the one or more basis attributes.

7. The method of claim 2, wherein said facilitating of an authorized user of the first organization in creating the first root offer data object instance further comprises faciliating an authorized user of the first organization in specifying creation completion of said offer, making said offer to be available for eligible organization(s) to accept or create counter offer(s) to said offer, via one or more of the one or more basis attributes.

8. The method of claim 2, wherein said facilitating of an authorized user of the first organization in creating the first root offer data object instance further comprises automatically adding to said first root offer data object instance, at least one of an identifier of the authorized user creating the first root offer data object instance, and an identifier of the first organization.

9. The method of claim 2, wherein said facilitating of an authorized user of the first organization in creating said offer further comprises facilitating an authorized user of the first organization in creating an offer term data object instance that is a child data object instance to said first root offer data object instance, with one or more attritbues specifying one or more terms, including a duration term and a compensation term, for any application service agreement resultantly formed based on the offer.

10. The method of claim 9, wherein said duration term is a selected one of an annual duration term, a semi-annual duration term, a quarterly duration term, a monthly duration term, a weekly duration term, and a daily duration term.

11. The method of claim 2, wherein said facilitating of an authorized user of the first organization in creating said offer further comprises facilitating an authorized user of the first organization in creating an offered item data object instance that is a child data object instance to said first root offer data object instance, with one or more attritbues specifying an offered item covered by any application service agreement resultantly formed based on the offer.

12. The method of claim 11, wherein said offered item is a selected one of a data object, a data service package comprising a plurality of data objects, and a data publication comprising one or more shared data objects published by one or more users of the first organization.

13. The method of claim 2, wherein said facilitating of an authorized user of the first organization in creating the first root offer data object instance further comprises faciliating an authorized user of the first organization in terminating said offer, via one or more of the one or more basis attributes.

14. The method of claim 2, wherein said facilitating of an authorized user of the second organization using the first one or more methods to accept the offer comprises facilitating an authorized user of the second organization in creating an offer acceptance data object instance that is a child data object instance to said first root offer data object instance, with one or more attributes specifying the second organization's acceptance of the offer, while the offer is available for acceptance.

15. The method of claim 14, wherein said facilitating of an authorized user of the second organization using the first one or more methods to accept the offer further comprises authenticating the second organization as an organization to which the offer is extended before facilitating said creating of the offer acceptance data object instance.

16. The method of claim 2, wherein said facilitating of an authorized user of the second organization using the first one or more methods to create a first counter offer to the offer comprises facilitating an authorized user of the second organization in creating a second root offer data object instance that is a child data object instance to said first root offer data object instance, with second one or more basis attributes defining the first counter offer, and the second root offer data object instance having association with the one or more methods for an authorized user of the first organization to accept the first counter offer or create the second counter offer to the first counter offer.

17. The method of claim 16, wherein the method further comprises facilitating an authorized user of the first organization in performing a selected one of
a) accepting the first counter offer,
b) creating the second counter offer to the first counter offer, with the second counter offer comprising third one or more offer data object instances, derived from the second one or more offer data object instances, having third one or more attributes describing said second counter offer, and the third one or more offer data object instances also having association with the one or more methods for an authorized user of the second organization to use to accept the second counter offer or create a third counter offer to the second counter offer.

18. In an application service environment, a computer assisted method for forming an application service agreement between a first and a second organization, the method comprising:
receiving from an authorized user of the first organization a plurality of values for a plurality of attributes defining an offer to form the application service agreement, including values specifying an offer type, one or more offered items, duration and compensation; and
in response, automatically creating the offer in a form of a first hierarchy of data object instances including
a root data object instance having an offer type attribute set with the provided offered type;
one or more child offered item data object instances that are child data object instances of the root data object instance, each having one or more offered item attributes defining an offered item;
an offered term data object instance that is a child data object instance of the root data object instance, having a duration term attribute and a compensation term attribute set with the provided during and compensation terms respectively.

19. The method of claim 18, wherein the offer type is selected from an offer type group having at least one of
a) a bilateral offer type denoting singular extension of an offer to a particularized organization of the application service environment,
b) a multilateral offer type denoting particularized plural extensions of an offer to a number of enumerated organizations of the application service environment, and
c) a unilateral offer type denoting general plurality extensions of an offer to all organizations of the application service environment.

20. The method of claim 19, wherein
said values received from the authorized user of the first organization further comprise values specifying one or more recipients of the offer, when the offer type is one of the bilateral and the multilateral type; and
the responsive creation of the offer further comprises creating an offer recipient data object instance that is a child data object instance to said root offer data object instance, with one or more offer recipient attritbues specifying one or more organizations to which the offer is extended.

21. The method of claim 19, wherein the method further comprises
receiving from an authorized user of the second organization a value specifying the second organization as an organization to which the offer is extended, when the offer type is an unliteral type; and
in response, creating an offer recipient data object instance that is a child data object instance to said root offer data object instance, with one or more offer recipient attritbues specifying the second organization.

22. The method of claim 18, wherein
said values received from the authorized user of the first organization further comprises one or more values specifying one or more of an offer date, an offer place, and a choice of law governing any application service agreement resulted from said offer; and
said responsive creation of the root offer data object instances further comprises setting one or more basis attributes with the one or more provided offer date, offer place, and choice of law.

23. The method of claim 18, wherein
said receiving further comprises receiving from the same or another authorized user of the first organization a value specifying creation completion of said offer; and
said responsive creation further comprises creating said root offer data object instance with a basis attribute set to denote completion of the offer, making said offer to be available for eligible organization(s) to accept or create counter offer(s) to said offer.

24. The method of claim 18, wherein said responsive creation of the root offer data object instance further comprises automatically adding to said root offer data object instance, at least one of an identifier of the authorized user creating the root offer data object instance, and an identifier of the first organization.

25. The method of claim 18, wherein said duration term is a selected one of an annual duration term, a semi-annual duration term, a quarterly duration term, a monthly duration term, a weekly duration term, and a daily duration term.

26. The method of claim 18, wherein said offered item is a selected one of a data object, a data service package comprising a plurality of data objects, and a data publication comprising one or more shared data objects published by one or more users of the first organization.

27. The method of claim 18, wherein the method further comprises
receiving from an authorized user of the first organization an indication to terminate said offer; and
in response, updating a basis attribute of the root offer data object instance to denote a terminated state of the offer, to render the offer ineligible for acceptance.

28. The method of claim 18, wherein the method further comprises facilitating an authorized user of the second organization in creating an offer acceptance data object instance that is a child data object instance to said root offer data object instance, with one or more attributes specifying the second organization's acceptance of the offer, while the offer is available for acceptance.

29. The method of claim 18, wherein said facilitating of an authorized user of the second organization to accept the offer further comprises authenticating the second organization as an organization to which the offer is extended before facilitating said creating of the offer acceptance data object instance.

30. The method of claim 18, wherein the method further comprises facilitating an authorized user of the second organization in creating a counter offer to said offer by creating a second hierarchy of offer data object instances defining the counter offer, that are descendant offer data object instances to said root offer data object instance of the original offer.

31. An apparatus comprising
storage medium having stored therein a plurality of programming instruction designed to enable the apparatus to facilitate formation of an application service agreement between a first and a second organization, including
facilitating an authorized user of the first organization in creating an offer to form said application service agreement, with the offer comprising first one or more offer data object instances having first one or more attributes describing the offer, and the first one or more offer data object instances having association with one or more methods for an authorized user of the second organization to accept the offer or create a first counter offer to the offer, and
facilitating an authorized user of the second organization using the first one or more methods to perform one of
a) accepting the offer,
b) creating a first counter offer to the offer, with the first counter offer comprising second one or more offer data object instances, derived from the first one or more offer data object instances, having second one or more attributes describing said first counter offer, and the second one or more offer data object instances also having association with the one or more methods for an authorized user of the first organization to use to accept the first counter offer or create a second counter offer to the first counter offer; and
at least one processor coupled to the storage medium to execute the programming instructions.

32. The apparatus of claim 31, wherein said programming instructions are designed to perform said facilitating of an authorized user of the first organization in creating said offer by facilitating an authorized user of the first organization in creating a first root offer data object instance having first one or more basis attributes defining basic aspects of the offer, with the first root offer data object instance having association with one or more methods for an authorized user of the second organization to accept the offer or create the first counter offer to the offer.

33. The apparatus of claim 32, wherein the first one or more basis attributes include an offer type attribute specifying an offer type of the offer, that is selected from an offer type group having at least one of
a) a bilateral offer type denoting singular extension of an offer to a particularized organization of the application service environment,
b) a multilateral offer type denoting particularized plural extensions of an offer to a number of enumerated organizations of the application service environment, and
c) a unilateral offer type denoting general plurality extensions of an offer to all organizations of the application service environment.

34. The apparatus of claim 33, wherein said programming instructions are further designed to enable the apparatus to facilitate an authorized user of the first organization in creating an offer recipient data object instance that is a child data object instance to said first root offer data object instance, with one or more attritbues specifying one or more organizations to which the offer is extended, when the offer type is one of the bilateral and the multilateral type.

35. The apparatus of claim 34, wherein said programming instructions are further designed to enable the apparatus to facilitate an authorized user of the second organization in creating an offer recipient data object instance that is a child data object instance to said first root offer data object instance, with one or more attritbues specifying the second organization as an organization to which the offer is extended, when the offer type is an unliteral type.

36. The apparatus of claim 32, wherein said programming instructions are designed to faciliate an authorized user of the first organization in specifying one or more of an offer date, an offer place, and a choice of law governing any application service agreement resulted from said offer, via one or more the one or more basis attributes, while performing said facilitating of an authorized user of the first organization in creating the first root offer data object instance.

37. The apparatus of claim 32, wherein said programming instructions are designed to faciliate an authorized user of the first organization in specifying creation completion of said offer, making said offer to be available for eligible organization(s) to accept or create counter offer(s) to said offer, via one or more of the one or more basis attributes, while performing said facilitating of an authorized user of the first organization in creating the first root offer data object instance.

38. The apparatus of claim 32, wherein said programming instructions are designed to automatically add to said first root offer data object instance, at least one of an identifier of the authorized user creating the first root offer data object instance, and an identifier of the first organization, while performing said facilitating of an authorized user of the first organization in creating the first root offer data object instance.

39. The apparatus of claim 32, wherein said programming instructions are further designed to facilitate an authorized user of the first organization in creating an offer term data object instance that is a child data object instance to said first root offer data object instance, with one or more attritbues specifying one or more terms, including a duration term and a compensation term, for any application service agreement resultantly formed based on the offer, while performing said facilitating of an authorized user of the first organization in creating said offer.

40. The apparatus of claim 39, wherein said duration term is a selected one of an annual duration term, a semi-annual duration term, a quarterly duration term, a monthly duration term, a weekly duration term, and a daily duration term.

41. The apparatus of claim 32, wherein said programming instructions are designed to facilitate an authorized user of the first organization in creating an offered item data object instance that is a child data object instance to said first root offer data object instance, with one or more attritbues specifying an offered item covered by any application service agreement resultantly formed based on the offer, while performing said facilitating of an authorized user of the first organization in creating said offer.

42. The apparatus of claim 41, wherein said offered item is a selected one of a data object, a data service package comprising a plurality of data objects, and a data publication comprising one or more shared data objects published by one or more users of the first organization.

43. The apparatus of claim 32, wherein said programming instructions are designed to faciliate an authorized user of the first organization in terminating said offer, via one or more of the one or more basis attributes, while performing said facilitating of an authorized user of the first organization in creating the first root offer data object instance.

44. The apparatus of claim 32, wherein said programming instructions are further designed to perform said facilitating of an authorized user of the second organization using the first one or more methods to accept the offer by facilitating an authorized user of the second organization in creating an offer acceptance data object instance that is a child data object instance to said first root offer data object instance, with one or more attributes specifying the second organization's acceptance of the offer, while the offer is available for acceptance.

45. The apparatus of claim 44, wherein said programming instructions are designed to authenticate the second organization as an organization to which the offer is extended before facilitating said creating of the offer acceptance data object instance, while performing said facilitating of an authorized user of the second organization using the first one or more methods to accept the offer.

46. The apparatus of claim 32, wherein said programming instructions are designed to perform said facilitating of an authorized user of the second organization using the first one or more methods to create a first counter offer to the offer by facilitating an authorized user of the second organization in creating a second root offer data object instance that is a child data object instance to said first root offer data object instance, with second one or more basis attributes defining the first counter offer, and the second root offer data object instance having association with the one or more methods for an authorized user of the first organization to accept the first counter offer or create the second counter offer to the first counter offer.

47. The apparatus of claim 46, wherein said programming instructions are further designed to enable the apparatus to facilitate an authorized user of the first organization in performing a selected one of
a) accepting the first counter offer,
b) creating the second counter offer to the first counter offer, with the second counter offer comprising third one or more offer data object instances, derived from the second one or more offer data object instances, having third one or more attributes describing said second counter offer, and the third one or more offer data object instances also having association with the one or more methods for an authorized user of the second organization to use to accept the second counter offer or create a third counter offer to the second counter offer.

48. An apparatus comprising:
storage medium having stored therein a plurality of programming instructions designed to enable the apparatus to facilitate formation of an application service agreement between a first and a second organization, including
receiving from an authorized user of the first organization a plurality of values for a plurality of attributes defining an offer to form the application service agreement, including values specifying an offer type, one or more offered items, duration and compensation, and
in response, automatically creating the offer in a form of a first hierarchy of data object instances including
a root data object instance having an offer type attribute set with the provided offered type,
one or more child offered item data object instances that are child data object instances of the root data object instance, each having one or more offered item attributes defining an offered item,
an offered term data object instance that is a child data object instance of the root data object instance, having a duration term attribute and a compensation term attribute set with the provided during and compensation terms respectively; and
at least one processor coupled to the storage medium to execute the programming instructions.

49. The apparatus of claim 48, wherein the offer type is selected from an offer type group having at least one of
a) a bilateral offer type denoting singular extension of an offer to a particularized organization of the application service environment,
b) a multilateral offer type denoting particularized plural extensions of an offer to a number of enumerated organizations of the application service environment, and
c) a unilateral offer type denoting general plurality extensions of an offer to all organizations of the application service environment.

50. The apparatus of claim 49, wherein
said values received from the authorized user of the first organization further comprise values specifying one or more recipients of the offer, when the offer type is one of the bilateral and the multilateral type; and
said programming instructions are further designed to enable the apparatus to create an offer recipient data object instance that is a child data object instance to said root offer data object instance, with one or more offer recipient attritbues specifying one or more organizations to which the offer is extended, while performing said responsive creation of the offer.

51. The apparatus of claim 49, wherein said programming instructions are further designed to enable the apparatus to
receive from an authorized user of the second organization a value specifying the second organization as an organization to which the offer is extended, when the offer type is an unliteral type; and
in response, create an offer recipient data object instance that is a child data object instance to said root offer data object instance, with one or more offer recipient attritbues specifying the second organization.

52. The apparatus of claim 48, wherein
said values received from the authorized user of the first organization further comprises one or more values specifying one or more of an offer date, an offer place, and a choice of law governing any application service agreement resulted from said offer; and
said programming instructions are further designed to enable the apparatus to set one or more basis attributes with the one or more provided offer date, offer place, and choice of law, while performing said responsive creation of the root offer data object instances.

53. The apparatus of claim 48, wherein said programming instructions are further designed to enable the apparatus to
receive from the same or another authorized user of the first organization a value specifying creation completion of said offer, while performing said receiving, and
create said root offer data object instance with a basis attribute set to denote completion of the offer, making said offer to be available for eligible organization(s) to accept or create counter offer(s) to said offer, while performing said responsive creation.

54. The apparatus of claim 48, wherein said programming instructions are further designed to enable the apparatus to automatically add to said root offer data object instance, at least one of an identifier of the authorized user creating the root offer data object instance, and an identifier of the first organization, while performing said responsive creation of the root offer data object instance.

55. The apparatus of claim 48, wherein said duration term is a selected one of an annual duration term, a semi-annual duration term, a quarterly duration term, a monthly duration term, a weekly duration term, and a daily duration term.

56. The apparatus of claim 48, wherein said offered item is a selected one of a data object, a data service package comprising a plurality of data objects, and a data publication comprising one or more shared data objects published by one or more users of the first organization.

57. The apparatus of claim 48, wherein said programming instructions are further designed to enable the apparatus to
receive from an authorized user of the first organization an indication to terminate said offer; and
in response, update a basis attribute of the root offer data object instance to denote a terminated state of the offer, to render the offer ineligible for acceptance.

58. The apparatus of claim 48, wherein said programming instructions are further designed to enable the apparatus to facilitate an authorized user of the second organization in creating an offer acceptance data object instance that is a child data object instance to said root offer data object instance, with one or more attributes specifying the second organization's acceptance of the offer, while the offer is available for acceptance.

59. The apparatus of claim 48, wherein said programming instructions are further designed to enable the apparatus to authenticate the second organization as an organization to which the offer is extended before facilitating said creating of the offer acceptance data object instance, while performing said facilitating of an authorized user of the second organization to accept the offer.

60. The apparatus of claim 48, wherein said programming instructions are further designed to enable the apparatus to facilitate an authorized user of the second organization in creating a counter offer to said offer by creating a second hierarchy of offer data object instances defining the counter offer, that are descendant offer data object instances to said root offer data object instance of the original offer.
